(19) United States
(12) Patent Application Publication
(10) Pub. No.: US 2009/0009286 A1
(43) Pub. Date: Jan. 8, 2009

(54) Picking assisting device

(75) Inventor: Hiroyuki Toida, Nagoya-shi (JP)

Correspondence Address: BIRCH STEWART KOLASCH & BIRCH, PO BOX 747, FALLS CHURCH, VA, 22040-0747, US

(73) Assignee: TOA Holdings, Inc.

(21) Appl. No.: 12/071,685

(22) Filed: Feb. 25, 2008

(30) Foreign Application Priority Data
Apr. 6, 2007 (JP) JP2007-100925

(51) Int. Cl. G05B 19/00

(52) U.S. Cl. 340/5.91

(57) ABSTRACT

A picking assisting device of the present invention is a device for assisting an operator in picking the article indicated by picking information from a storage rack where storing various articles. A display response device is installed in each storage section of the storage rack, and each display response device includes a picking display lamp that lights up to indicate the storage section to be picked, a numerical value display for displaying the number of pieces of articles to be picked, and a completion switch operated by the operator for generating a signal indicative of the completion of picking. Further, a blocking arm is provided to a front surface of each storage section of the storage rack. The blocking arm of each storage section is operated by an arm driving mechanism to open the front surface of the storage section indicated by the picking information whereas to keep the front surfaces of the remaining storage sections blocked.

### BACKGROUND OF THE INVENTION

1. FIELD OF THE INVENTION

The present invention relates to a picking assisting device for, when an operator picks articles which he is instructed to pick from storage racks where the articles are stored, assisting the picking operation.

2. DESCRIPTION OF RELATED ART

Conventionally, a picking assisting device is known in Japanese Laid-Open Patent Publication No. 2005-170584 and the like.. The picking assisting device is installed in a system where various parts are stored in a storage rack and an operator picks required parts from the storage rack. The picking assisting device includes a display response device installed in each storage location of the storage rack. Information about the number of pieces of parts to be picked is transmitted to the display response device so as to be displayed on the display of the display response device, thereby assisting an operator in picking parts.

In performing picking, picking information is sent to the display response device at the storage location that was instructed, so as to light up a picking display lamp installed in the display response device to indicate the picking location as well as to display the number of parts to be picked on a numeric value display. The operator who performs the picking operation visually confirms the picking display lamp and the numeric value display, and takes out the specified parts in the specified number of pieces as instructed.

Thus, the conventional picking assisting device is installed in each storage location of the storage rack, and merely gives an operator the instruction for picking operation by turning on the picking display lamp at the storage location where the parts to be taken out are stored. Therefore, in the case where a large number of parts is to be taken out of a large number of storage racks, if misunderstanding occurs in the recognition of the operator, there is a fear that a mistake arises in the picking operation of the operator, which may be resulting in picking of wrong parts, when only with the indication of the picking display lamp.

### SUMMARY OF THE INVENTION

An objective of the invention is to provide a picking assisting device capable of effectively reducing errors in picking operations of operators. The objective of the present invention can be achieved by the picking assisting device structured as follows.

Specifically, the picking assisting device of the present invention includes a display response device in each storage section of a storage rack. Each display response device includes a picking display lamp that lights up to indicate and instruct an operator the storage section storing an article to be picked, a numeric value display provided to said display response device that displays the number of the articles to be picked, and a completion switch provided to said display response device for generating a signal indicative of completion of picking operation when operated by an operator. Further, a blocking arm is provided to a front surface of each storage section of the storage rack so as to block and open the front surface when being driven by an arm driving mechanism. In a normal state, the arm driving mechanism keeps the blocking arm stopped at a blocking position. When article picking information is transmitted to the display response device, the arm driving mechanism drives the blocking arm to move to an opening position.

Here, a case main body of the display response device is attached to an upper portion on the front surface of each storage section of said storage rack, and the arm driving mechanism of said blocking arm is structured with the blocking arm provided within the case main body in a rotatably driven manner. In a normal state, the arm driving mechanism keeps the blocking arm stopped at a blocking position oriented obliquely downward. Further, the arm driving mechanism can be structured such that, when article picking information is transmitted to the display response device, the arm driving mechanism turns the blocking arm to a horizontal position so as to open the front surface of said storage section.

Further, the arm driving mechanism includes a motor for rotation drive within the case thereof. The rotational shaft of the arm driving mechanism that is engaged with a main shaft of the motor via a plurality of deceleration gears is rotatably supported within the case. Then, a base portion of the blocking arm can be fixed to the arm with the arm oriented toward a direction perpendicular to an axial direction of the rotational shaft.

In the picking assisting device described above, in the normal state where no picking information of articles (i.e. shipping information of parts and the like) is transmitted to the display response devices, each blocking arm is kept stopped at the position where it blocks the front surface of each storage section of the storage rack. When picking information of articles is transmitted to the display response device of the storage section, the arm driving mechanism installed in the display response device of said storage section is actuated, and turns or moves the blocking arm to the position for opening the front surface of the storage section.

Accordingly, the front surface of said storage section is opened and the operator will take out the articles stored in the storage section. However, on the other hand, at the storage sections of the remaining display response devices to which no picking information of articles is transmitted, the blocking arm is stopped at the blocking position so as to close the front surface of the storage section, and mistakes of taking out wrong articles from the storage section will be reduced due to the blocking arm, thereby efficiently preventing the operator form making mistake in picking operation.

### BRIEF DESCRIPTION OF THE DRAWINGS

FIG. 1 is a front view of a storage rack equipped with a picking assisting device showing an embodiment of the present invention;

FIG. 2 is a front view of a display response device;

FIG. 3 is a perspective view of the display response device;

FIG. 4 is a perspective view of the display response device at its back surface side;

FIG. 5 is an enlarged cross-sectional view of an arm driving mechanism; and

FIG. 6 is a schematic constitutional block diagram of a picking assisting system.

### DESCRIPTION OF THE PREFERRED EMBODIMENTS

A description follows of the present invention according to the embodiments shown in the drawings. It should be noted that the present invention is not limited to these embodiments. All changes to what is required in claims, or to equivalents about such requirements, are covered by the claims.

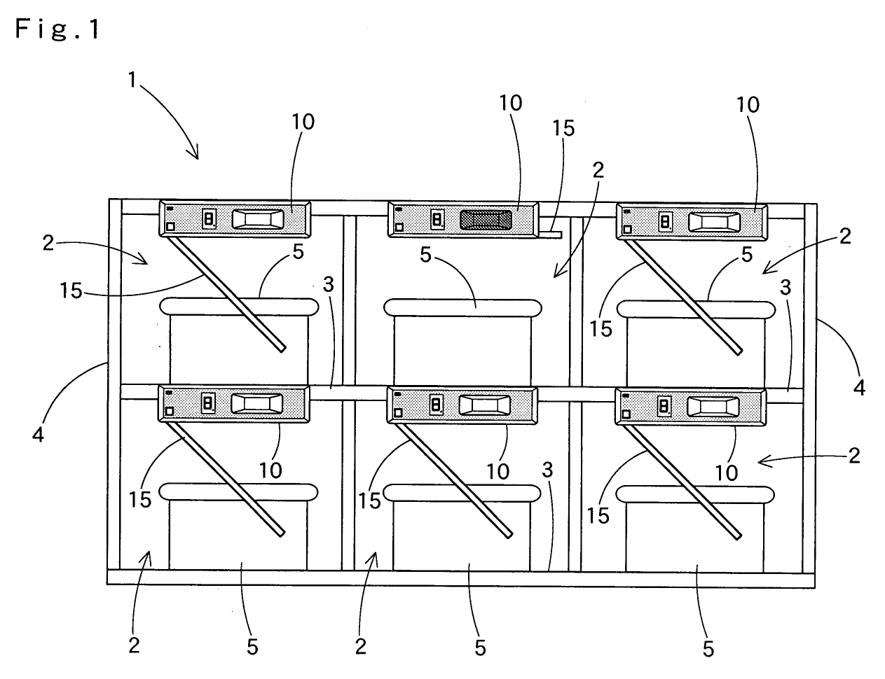

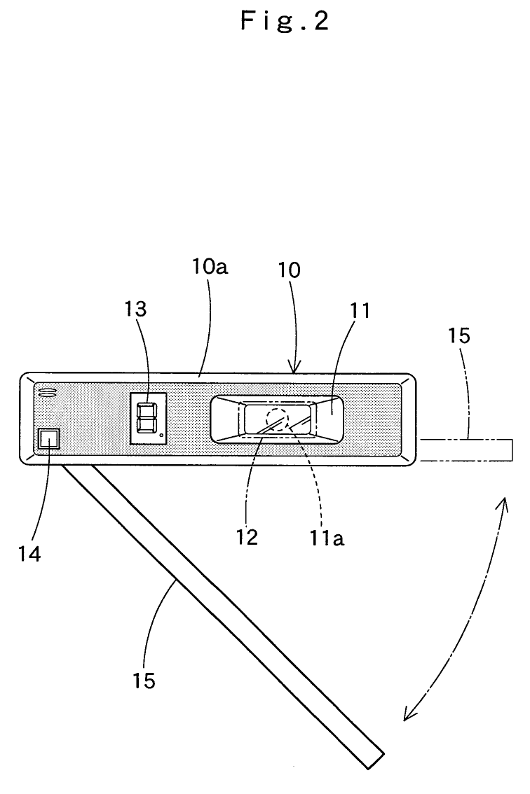

FIG. 1 shows a front view of a picking assisting device provided to a storage rack 1 for storing articles, and FIG. 2 shows a front view of a display response device installed in each storage section 2. The storage rack 1 for picking articles is formed, for example, in the shape of a rack having a pipe frame structure formed with, in the example shown in FIG. 1, two upper and lower shelves 3 each including three storage sections 2 arranged in parallel to one another. Alternatively, the number of the storage section 2 may be increased to more than six, or may be reduced to less than six by increasing and decreasing the pipe frames connected. The front surface of each storage section 2 in the storage rack 1 is opened. On the shelf 3 in each storage section 2, an article storage box 5 for storing a kind of parts is placed. An operator can take out articles from the article storage box 5 placed in each storage section 2.

Further, at the upper portion on the front surface of each storage section 2, a display response device 10 is mounted for giving picking instruction to an operator as well as for generating completion signal at the time when picking is completed. This display response device 10 is basically constituted by attaching a picking display lamp 11, a numeric value display 13, and a completion switch 12 to the front surface of a case main body 10a. The picking display lamp 11 turns on a display lamp 11a so as to indicate the storage section to instruct the operator to take out an article therefrom. The numeric value indicator 13 indicates the number of articles to be picked.

Further, the completion switch 12 is a switch operated by the operator when he completed the picking operation. When operated, the completion switch 12 responds by outputting a completion signal. Further, a reset switch 14 is provided on the left end on the case main body 10a. In the case where an operator is about to take out the article which he was instructed to take out but there is no stock left for taking out, the operator operates the reset switch to generate a picking disabling signal, causing next picking information to be displayed.

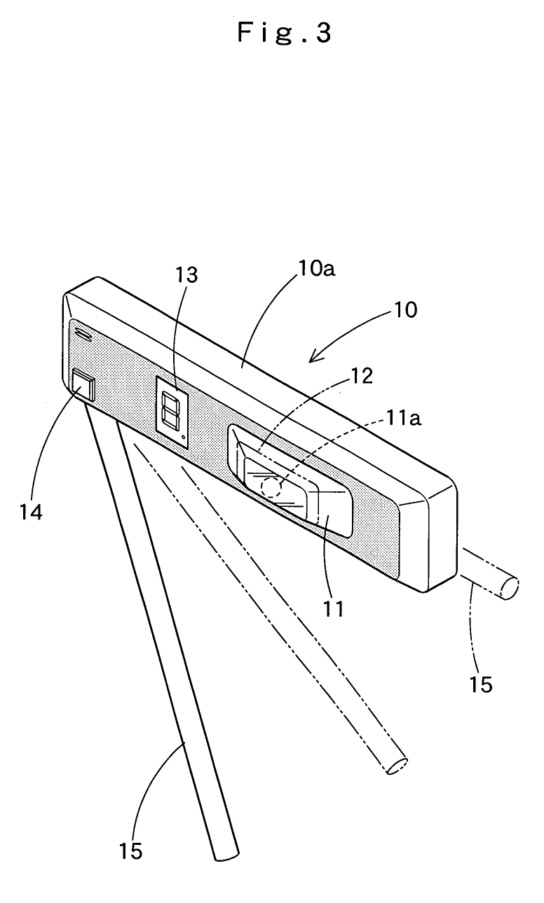

Further, as shown in FIGS. 2 and 3, a blocking arm 15 is attached to the lower portion of the case main body 10a in a rotatable manner by the arm driving mechanism 16 so that the blocking arm 15 blocks or opens the front surface of the storage section 2. In the normal state, the arm driving mechanism 16 keeps the blocking arm 15 stopped at a blocking position. When article picking information is transmitted to the display response device 10, the arm driving mechanism 16 is actuated to turn the blocking arm to the opening position.

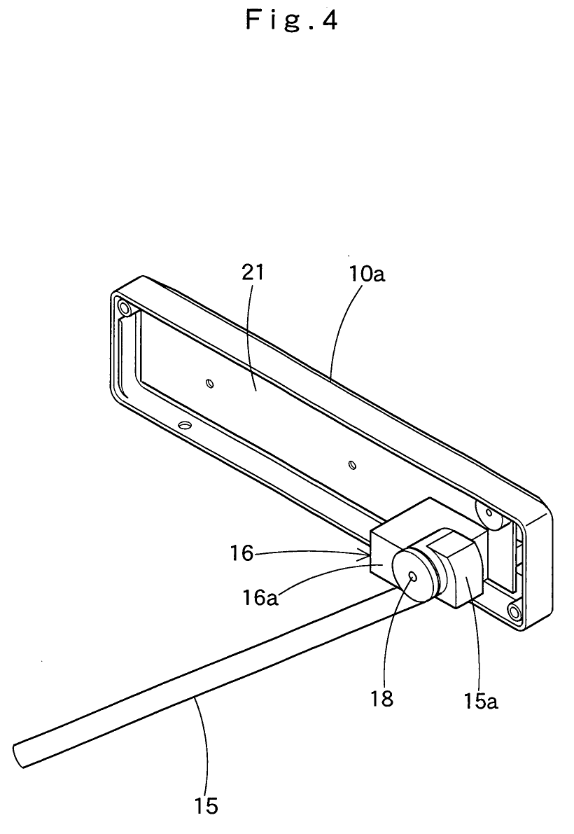

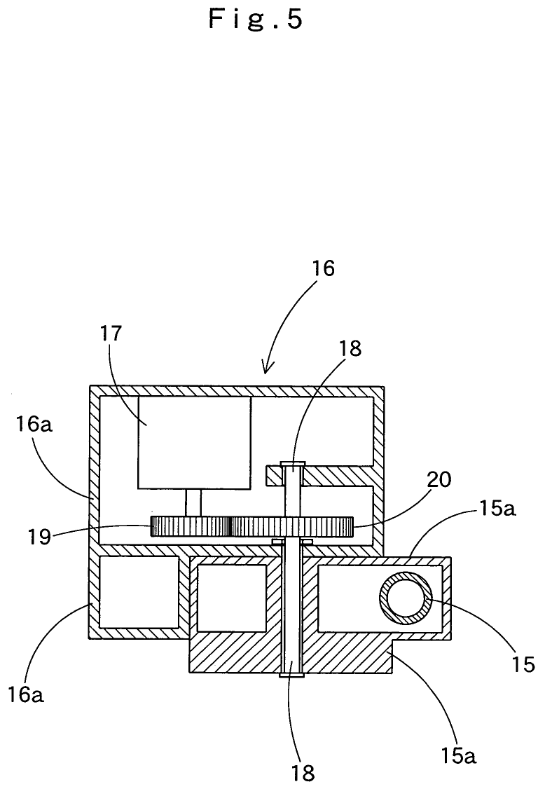

As shown in FIGS. 4 and 5, the arm driving mechanism of the blocking arm 15 is provided within the case main body 10a of the display response device 10. In the normal state, the arm driving mechanism 16 turns the blocking arm and keeps it at the blocking position oriented obliquely downward, that is, keeps the blocking arm 15 stopped at an inclined angle at, for example, 45 degrees relative to the vertical axis. In this manner, when an operator tries to put his hand into the article storage box 5 to take out an article, this action is physically blocked by the blocking arm 15.

On the other hand, when the article picking information is transmitted to the display response device 10 corresponding to said information, the arm driving mechanism 16 drives the corresponding blocking arm 15 to be turned to the horizontal position in the vicinity of the case main body 10a to open the front surface of the storage section 2, so that the operator is allowed to take out an article from the article storage box 5 of the storage section 2.

To achieve the above operation, the arm driving mechanism 16 includes a motor 17 in its case 16a. The motor 17 rotatably supports a rotational shaft 18 at which the base portion of the blocking arm 15 is fixed. As shown in FIG. 5, the rotational shaft 18 is rotatably supported by a bearing portion within the case 16a in such a manner that the top end portion of the rotational shaft 18 protrudes from the inside of the case 16a. The rotational shaft 18 and the main shaft of the motor 17 are engaged with each other via deceleration gears 19 and 20. The base portion 15a of the blocking arm 15 is fixed to the top end portion of the rotational shaft 18 protruding from the case 16a. The base portion 15a of the blocking arm 15 is fixed to the top end portion of the rotational shaft 18 in such a manner that the axis of the blocking arm becomes orthogonal to the axial direction of the rotational shaft 18.

Further, as shown in FIG. 5, the base portion 15a of the blocking arm 15 is fitted into the recessed portion provided in the case 16a at its rotational shaft side, and it is kept rotatable by a circular arc-like wall portion 16b of the recessed portion. Thereby, when a load is applied to the blocking arm 15 from the outside, the circular arc-like wall portion 16b sustains this load so as to prevent damage to the base portion 15a of the blocking arm 15.

As shown in FIG. 4, the blocking arm 15 is turned such that it protrudes downward from the inside of the case main body 10a. To this end, an unillustrated attachment case, provided to the storage rack side at which the case main body 10a is fixed, is formed with an opening. When the case main body 10a is assembled to the attachment case in such a manner that the case main body 10a covers the front surface of the attachment case, the blocking arm 15 comes into a state where it protrudes downward from the opening.

As described above, the arm driving mechanism 16 including the blocking arm 15 is attached in a state where it is incorporated within the case main body 10a of the display response device 10. Due to this structure, as compared with a case where the arm driving mechanism 16 is attached independently of the case main body 10a of the display response device 10, the number of parts used can be reduced and the structure of the front portion of each storage section 2 can be simplified.

As shown in FIG. 4, the display response device 10 includes a circuit board 21 mounted therein. One the circuit board 21, mounted are unillustrated devices of a one-board CPU consisting of a CPU, a ROM, a RAM, and an input/output circuit, a seven-segmented liquid crystal display which is used as the numeric value display 13, an LED as a display lamp 11a, a completion switch 12 for generating completion signals, a reset switch 14 for generating reset signals, and a driving circuit for the motor which drives the blocking arm 15.

The display response device 10 is schematically constituted of a small-sized one-board CPU comprising items such as a ROM, a RAM, and an input/output portion as a main section. The display response device 10 receives picking information transmitted from a later-described picking control unit 30 and sent via a relay unit 31 based on program data written in the ROM in advance. Then, on the basis of the picking information, the display response device causes the display lamp 11a to light up. Furthermore, the display response device 10 drives the driving circuit for motor to drive and rotate the motor 17, so that the blocking arm 15 is turned upward so as to open the front surface of the storage section 2 where this display response device 10 is installed. At the same time, the display response device causes the numeric value display 13 to display the number of articles to be picked. Further, when the operator has completed the picking operation based on the picking information and turns on the completion switch 12, the display response device 10 stores the picking completed state, and upon reception of a polling control signal that is sent from the relay unit 31, transmits this picking completion signal to the relay unit 31.

The picking display lamp 11 mounted to the front surface of the display response device 10 is constituted such that it serves as both a picking indicator light and a completion switch to be operated when the picking is completed. Specifically, the picking display lamp 11 includes a display lamp 11a inside its transparent portion at the front surface. At the time of loading picking information, the picking display lamp 11 turns on the display lamp 11a. Further, the transparent portion at the front surface of the picking display lamp 11 is formed so that it can be pressed. By pressing the transparent portion, the completion switch 12 provided inside the transparent portion is turned on. The completion switch 12 to be operated at the time when the picking operation is completed may be provided separately from the picking display lamp 11 which lights up to instruct picking operation.

As shown in FIG. 1, the display response device 10 is installed in each storage section 2 of the storage rack 1. A plurality of display response devices 10 installed in one set of storage rack 1 is connected to the relay unit 31 in, for example, two-wire communication system conforming to the RS-485 standards. Since a plurality of display response devices 10 is connected to one set of relay unit 31, an address is assigned to each display response device 10 in order to identify the individual display response devices 10. Further, each display response device 10 includes a receiving section and a transmitting section for data communication conforming to, for example, the RS-485 standards.

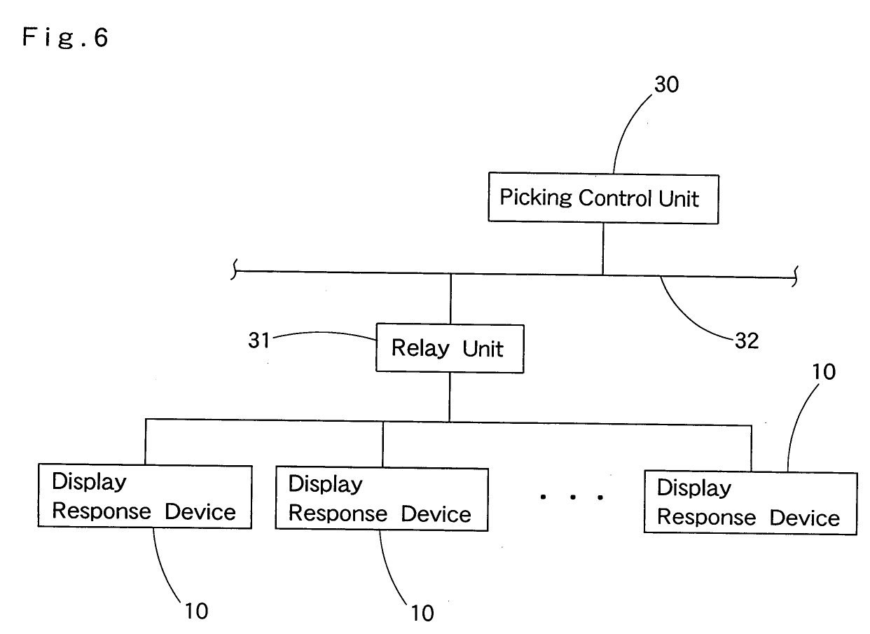

As shown in FIG. 6, each display response device 10 installed in storage section 2 of the storage rack 1 is connected to the relay unit 31 via the communication wire of a two-wire system. In turn, the relay unit 31 is connected to a picking control unit 30 via a LAN cable 32 and an unillustrated hub or the like. One set of the relay unit 31 is installed in, for example, one set of the storage rack 1. When a plurality of storage racks 1 is used in combination, a plurality of relay units 31 is connected to a picking control unit 30 via the LAN cable 32 so that the relay units 31 are mutually communicable. Data communication between the picking control unit 30 and the plurality of relay units 31 is performed using, for example, the TCP/IP communication protocol. The picking control unit 30 and each relay unit 31 respectively include an IP address for identifying themselves, and perform data communication using these IP addresses.

The relay unit 31 is constituted of a single board computer including a CPU, a ROM, a RAM, input/output circuits, and the like. The relay unit 31 has a LAN interface, and it is connected to the picking control unit 30 via the LAN cable. The relay unit 31 mutually communicates with the picking control unit 30 using a communication protocol such as the TCP/IP. Usually, a plurality of relay units 31 is installed. Each relay unit 31 has its specific IP address assigned thereto, and thus, each relay unit 31 can be identified by the IP address.

Further, as described above, a plurality of display response devices 10 individually attached to the storage section 2 is connected to the relay unit 31 in the two-wire communication system conforming to the RS-485 standards. The relay unit 31 converts picking information sent from the picking control unit 30 into a decryptable format and then transmits it to a plurality of display response devices 10. Further, after the transmitting the picking information to the display response device 10, the relay unit 31 sends a polling control signal to each display response device 10, and receives a response signal, such as a completion switch signal transmitted from the display response device 10 in response to the polling. Then, the relay unit 31 converts a response signal such as the completion switch signal into a decryptable format and transmits it to the picking control unit 30.

The picking control unit 30 is constituted of, for example, a general-purpose personal computer, in a constitution such that to an LAN adapter that is mounted on the computer, one or a plurality of relay units 31 are connected via the LAN cable 32. In the picking control unit 30, software prepared in advance for assisting in picking operations is stored in a ROM and the like, so that information for picking operations, that is, an identification code of each article storage box 5, the article numbers of articles to be stored and the number of pieces of the articles that have already been stored, are stored in the format of a data table. Then, in the picking operation, information about the article numbers of the articles to be picked and the number of pieces of the articles are input as picking information into the picking control unit 30.

Next, operation of the picking assisting device structured as described above is described. In conducting a picking operation, information about a picking control command signal including the article number of the articles to be picked and the number of pieces of the articles to be picked is transmitted from the picking control unit 30 to the relay unit 31.

Upon receiving the picking control command signal, based on the picking information thereof, the relay unit 31 transmits to the display response device 10 a picking command signal including the address assigned to the display response device 10 of the storage section 2 which stores the articles to be picked. This display response device 10, upon receiving the picking command signal including picking information that is addressed to itself, lights up the display lamp 11a of the picking display lamp 11, and at the same time actuates the motor 17 to drive and rotate the arm driving mechanism 16, and further, displays the number of pieces of the articles to be picked up on the numeric value display 13.

As a result that the arm driving mechanism 16 is driven to be rotated by the motor 17, its rotational shaft 18 is rotated, causing the blocking arm 15 attached thereto to start turning upward. Accordingly, as shown in FIGS. 1 and 2, the blocking arm 15, stayed in the posture oriented obliquely downward for blocking the front surface of the storage section 2, is turned into the upward horizontal posture, so that the front surface of the storage section 2 is opened.

An operator visually recognizes that the display lamp 11a of the picking display lamp 11 lights up, and takes out the article from the article storage box 5 of the storage section 2 at that location. At this time, since the blocking arm 15 has already changed into the opening posture from the blocking posture, the operator can pick up the article correctly.

Specifically, at the storage sections 2 of the remaining display response devices 10 to which an article picking command signal has not been sent, the blocking arms 15 are kept turned to the blocking positions where they block the front surface of these storage sections 2. Due to the blocking arms 15, an accident that the operator erroneously takes out articles from a wrong storage section 2 is hard to occur, and instead, the operator can take out articles from the article storage box 5 of a correct storage section 2 without error.

After taking out the article, the operator turns on the completion switch 12 of the display response device 10 in order to input a signal indicative of completion of picking operation. At this time, the display response device 10 temporarily stores the completion signal. Then, upon receiving a polling control signal transmitted from the relay unit 31, the display response device 10 transmits the completion signal to the relay unit 31. Upon receiving the picking completion signal, the relay unit 31 transmits a picking operation completion signal to the picking control unit 30 which was the original sender of the command for the picking operation.

On the other hand, at the time when the operator attempts to take out an article from the article storage box 5 of the storage section 2 as instructed, but he cannot take out any article because of the shortage of articles and the like, the operator turns on the reset switch 14. At this time, a picking disable signal is sent from the display response device 10 to the relay unit 31. In turn, a signal indicating that the picking operation is disabled is transmitted to the picking control unit 30.

As described above, the blocking arm 15 is mounted to each storage section 2 of the storage rack 1 which is to be subjected to picking. The blocking arm 15 is turned to the position where it blocks the front surface of the storage section 2 or to the position where it opens the front surface of the storage section 2 in accordance with the presence or absence of a picking command signal. At the storage sections 2 of the remaining display response devices 10 to which the article picking command signal has not been transmitted, the blocking arms 15 are in a turned state at the blocking positions where they block the front surface of the storage sections 2. Therefore, an accident that the operator erroneously takes out articles from a wrong storage section 2 is hard to occur, and the error in the picking operation by the operator can be effectively prevented.

Alternative to the embodiment described above, the present invention may be carried out in the following embodiments, and the same functions and effects as of the above can be achieved.

In the embodiment described above, the blocking arm 15 assumes a posture extending obliquely inclined at about 45 degrees so as to block the front surface of the storage section. Alternatively, the blocking arm 15 may be stopped at an inclined angle other than 45 degrees to block the front surface thereof. Still alternatively, the front surface of the storage section may be blocked by the blocking arm suspended substantially vertically downward.

Further, in the embodiment described above, the arm driving mechanism 16 is mounted within the case main body 10a of the display response device 10. Alternatively, the arm driving mechanism and the blocking arm may be mounted to the outside of the case main body 10a of the display response device 10. In such a case, for example, the arm driving mechanism is mounted to the left or right side portion of the front surface of the storage section with the blocking arm extending horizontally to block the front surface of the storage section. Then, the storage section may be opened by turning the blocking arm vertically upward or downward.

Further, in the embodiment described above, the motor 17 is used in the arm driving mechanism 16. Instead of the motor, an electromagnetic solenoid may be mounted, and the blocking arm may be turned by the electromagnetic solenoid.

Further, instead of rotational structure, the blocking arm may be in a structure movable up and down by which the blocking arm moves down to be in a blocking posture and moves up to be in an opening posture.

What is claimed is:

1. A picking assisting device comprising:
a picking display lamp, provided to a display response device allocated to each storage section of a storage rack for storing articles, for lighting up to indicate and instruct an operator the storage section where an article to be picked;
a numeric value display provided to said display response device, for displaying the number of pieces of the articles to be picked;
a completion switch provided to said display response device, for generating a signal indicative of completion of picking when operated by an operator; and
a blocking arm provided to a front surface of each storage section of said storage rack, for blocking or opening said front surface when being driven by an arm driving mechanism,
wherein said arm driving mechanism keeps the blocking arm stopped at a blocking position in a normal state, and when article picking information is transmitted to said display response device, said arm driving mechanism drives said blocking arm of said storage section indicated by said picking information to move to an opening position.

2. The picking assisting device according to claim 1, wherein a case main body of said display response device is attached to an upper portion on the front surface of each storage section of said storage rack, and the arm driving mechanism of said blocking arm is structured with the blocking arm provided within said case main body to be rotatably driven, and in a normal state, said arm driving mechanism keeps said blocking arm stopped at a blocking position oriented obliquely downward, and when article picking information is transmitted to said display response device, the arm driving mechanism turns said blocking arm to a horizontal position to open the front surface of said storage section.

3. The picking assisting device according to claim 2, wherein said arm driving mechanism includes a motor for rotation drive within the case thereof, a rotational shaft of the arm driving mechanism engaged with a main shaft of said motor via a plurality of deceleration gears is rotatably supported within said case, and a base portion of said blocking arm is fixed to said arm with said arm oriented toward a direction perpendicular to an axial direction of said rotational shaft.
